(19) United States
(12) Patent Application Publication
(10) Pub. No.: US 2026/0257230 A1
(43) Pub. Date: Sep. 3, 2026

(54) A SEPARATION SYSTEM FOR SEPARATING A LIQUID MIXTURE

(71) Applicant: Alfa Laval Corporate AB, LUND (SE)

(72) Inventor: Per-Gustaf LARSSON, HUDDINGE (SE)

(73) Assignee: Alfa Laval Corporate AB, LUND (SE)

(21) Appl. No.: 18/870,869

(22) PCT Filed: Jun. 8, 2023
(86) PCT No.: PCT/EP2023/065411

§ 371 Date: Dec. 2, 2024

(30) Foreign Application Priority Data
Jun. 30, 2022 (EP) 22182137.4

(51) Int. Cl. B04B 11/02; B04B 13/00

(52) U.S. Cl. CPC B04B 11/02; B04B 13/00

(57) ABSTRACT

A separation system includes a centrifugal separator for separating a liquid feed mixture. The centrifugal separator is arranged for separating the liquid feed mixture into at least one separated liquid phase and discharging said at least one separated liquid phase. The separation system includes a flow measurement arrangement arranged for receiving a measurement liquid selected from the liquid feed mixture and a separated liquid phase. The flow measurement arrangement includes a first container for holding measurement liquid; a first device for measuring a parameter related to the weight of measurement liquid contained in the first container, a second container for holding measurement liquid, and a second device for measuring a parameter related to the weight of measurement liquid contained in the second container. The flow measurement arrangement is arranged to allow emptying the first container of measurement liquid while a further container of the flow measurement arrangement is being filled with the same type of measurement liquid and vice versa, thereby allowing alternately filling the first and the further container of the flow measurement arrangement with the same type of measurement liquid.

### TECHNICAL FIELD

The present inventive concept relates to the field of centrifugal separators.

More particularly, it relates to a separation system and method for measuring a liquid flow to and/or from a centrifugal separator.

### BACKGROUND

Centrifugal separators are generally used for separation of liquids and/or solids from a liquid mixture or a gas mixture. During operation, fluid mixture that is about to be separated is introduced into a rotating bowl and due to the centrifugal forces, heavy particles or denser liquid, such as water, accumulates at the periphery of the rotating bowl whereas less dense liquid accumulates closer to the central axis of rotation. This allows for collection of the separated fractions, e.g. by means of different outlets arranged at the periphery and close to the rotational axis, respectively.

The traditional way of measuring a liquid flow of the separated liquid phase from a centrifugal separator is using a flow sensor. Flow sensors are expensive in general and it may be difficult to select an appropriate flow sensor for a specific application since flow sensors may depend on several different measuring principles, all with their own advantages and disadvantages. Measurement errors normally occur if one wants to measure different liquids with the same flow sensor or if the temperature or liquid composition varies over time.

WO 2021/191023 discloses a system and method of determining the flow rate, such as mass flow, of a liquid phase discharged from a centrifugal separator. For this, a container arranged downstream of any of the liquid outlets is used. Further, there is a scale for measuring the weight of the discharged liquid phase contained in the container. With such knowledge, the mass increase per time may be calculated and thus the flow rate of the discharged liquid phase.

However, there may be a need to further improve the measurement method in such a system.

### SUMMARY

It is an object of the invention to at least partly overcome one or more limitations of the prior art. In particular, it is an object to provide a separator and a method for determining the flow rate of a measurement liquid with improved duty cycle during which flow measurements may be carried out.

As a first aspect of the invention, there is provided a separation system comprising a centrifugal separator for separating a liquid feed mixture. The centrifugal separator is arranged for separating the liquid feed mixture into at least one separated liquid phase and discharging said at least one separated liquid phase. The separation system further comprises
a flow measurement arrangement arranged for receiving a measurement liquid selected from the liquid feed mixture and a separated liquid phase, wherein the flow measurement arrangement comprises
a first container for holding measurement liquid;
a first device for measuring a parameter related to the weight of measurement liquid contained in said first container,
a second container for holding measurement liquid,
a second device for measuring a parameter related to the weight of measurement liquid contained in said second container,
wherein the flow measurement arrangement is further arranged to allow emptying said first container of measurement liquid while a further container of the flow measurement arrangement is being filled with the same type of measurement liquid and vice versa, thereby allowing alternately filling the first and a further container of the flow measurement arrangement with the same type of measurement liquid.

The centrifugal separator may be as disclosed in WO 2021/191023. Thus, the centrifugal separator may have a rotatable assembly that is arranged for multiple use, such as a traditional stainless steel centrifuge bowl, or a rotatable assembly that arranged for single use, such as a replaceable insert as known from e.g. WO 2020/120357. Thus, in embodiments of the first aspect, the rotatable assembly may comprise an exchangeable separation insert and a rotatable member; the insert comprising the rotor casing and being supported by the rotatable member. Such an exchangeable separation insert may thus be a pre-assembled insert being mounted into a rotatable support for the insert. The exchangeable insert may thus easily be inserted into and taken out of the rotatable support as a single unit.

According to embodiments, such exchangeable separation insert is a single use separation insert. Thus, the insert may be adapted for single use and be a disposable insert. The exchangeable insert may thus be for processing of one product batch, such as a single product batch in the pharmaceutical industry, and then be disposed. The exchangeable separation insert may comprise a polymeric material or consist of a polymeric material.

The centrifugal separator may be arranged for separating the liquid feed mixture into two liquid phases, such as a liquid light phase and a liquid heavy phase, in which the liquid heavy phase has a density that is higher than the liquid light phase. Consequently, the centrifugal separator may comprise a single outlet for a discharged liquid phase or two outlets for discharged liquid phases.

The flow measurement arrangement is arranged to allow emptying a container of measurement liquid while a further container of the flow measurement arrangement is being filled with the same type of measurement liquid and vice versa. This thus allows for alternately filling the first and a further container of the flow measurement arrangement with the same type of measurement liquid. In other words, a flow measurement arrangement allows for alternately filling the first and a further container of the flow measurement arrangement with the liquid feed mixture or one of the separated liquid phases.

The flow measurement arrangement of the present disclosure may be arranged for measuring the flow rate of the inlet feed mixture.

Thus, in embodiments of the first aspect, the flow measurement arrangement is arranged upstream of an inlet of the centrifugal separator for measuring the flow rate of the liquid feed mixture. Consequently, in embodiments, the measurement liquid is the liquid feed mixture.

The flow measurement arrangement of the present disclosure may as a complement or alternative be arranged for measuring the flow rate of a separated liquid phase from the centrifugal separator. Thus, in embodiments of the first aspect, the flow measurement arrangement is arranged downstream a liquid outlet of the centrifugal separator, such as downstream of a liquid outlet for discharging a separated liquid light phase and/or downstream a liquid outlet for discharging a separated liquid heavy phase.

The flow measurement arrangement of the present disclosure may be arranged downstream the liquid outlet of a centrifugal separator if the centrifugal separator has a single outlet for a separated liquid phase, or may be arranged downstream one or both of the liquid outlets of centrifugal separator having two liquid outlets for two different separated phases.

Consequently, in embodiments, the measurement liquid is a separated liquid phase, such as a separated liquid light phase or a separated liquid heavy phase.

The first and second containers may be suspended in the first and second devices, respectively, for measuring a parameter related to the weight of measurement liquid. The containers may be suspended in a suspension direction that is substantially in the vertical direction.

The first aspect of the invention is based on the insight that having more than one container for measuring the flow of a type of measurement liquid is an advantage, since it allows for an almost continuous determination of the flow rate of a measurement liquid. With only one container, the flow rate may be difficult to determine during emptying of the container. More than one container, such as two containers, thus increase the duty cycle when using a container and load cell to measure e.g. mass flow of the measurement liquid. Thus, one container may be used for measurement when a further container, such as the second container, is off-line and/or in emptying stage. This enables almost a 100% measurement duty cycle.

Moreover, the flow measurement arrangement takes up little space, i.e. it is an advantage to use the flow measurement arrangement in applications where decreased footprint is useful, such as in single use processing lines for producing a biopharmaceutical.

A single flow measurement system is arranged either upstream of the inlet or downstream of one of the liquid outlets. However, the separation system may comprise more than one flow measurement system. A single flow measurement system may be arranged for receiving a single measurement liquid, such as the liquid feed mixture or a separated liquid phase, during a separation process.

The flow measurement arrangement of the present disclosure may comprise more than two containers for alternately being filled and emptied with the same type of measurement liquid. Hence, the flow measurement arrangement of the present disclosure may comprise further containers and further devices for measuring a parameter related to the weight of measurement liquid contained in such further containers. As an example, the flow measurement arrangement may comprise at least three, such as at least four containers.

In the simplest design, the flow measurement arrangement has only the first and second containers.

Consequently, in embodiments of the first aspect, the further container of the flow measurement arrangement is the second container. Therefore, the flow measurement arrangement may be arranged to allow emptying said first container of measurement liquid while the second container is being filled with measurement liquid and vice versa, thereby allowing alternately filling the first and second containers with the same type of measurement liquid.

Herein below, the flow measurement arrangement will be discussed mainly as having only the first and second containers. However, the skilled person would understand how to adapt and use a flow measurement arrangement having more than two containers for alternately filling the first and a further container of the flow measurement arrangement with the same type of measurement liquid for an almost continuous determination of the flow rate of a measurement liquid.

The flow rate may be determined as mass flow. The mass flow may be calculated by determining a weight increase (Δw) of a container during a time interval (Δt), and then estimate Δw/Δt. The volume flow may be determined from the mass flow using the density of the liquid phase entering the container.

In embodiments of the first aspect, the flow measurement arrangement comprises a tubing arrangement for transporting measurement liquid to and from the first container and to and from the second container.

The tubing of the tubing arrangement may be a polymeric tubing, such as a silicone tubing. Such tubing may have a large wall thickness. The tubing arrangement is thus arranged for receiving measurement liquid and for allowing transport of measurement liquid that has been emptied from the containers to process equipment downstream of the separation system. Thus, the tubing arrangement is in fluid contact with a liquid outlet of the centrifugal separator and may be connected to further tubing or pipes downstream of the flow measurement arrangement.

As an example, the tubing arrangement may comprise a single inlet tubing for receiving the measurement liquid that is to be filled in the first and the second container.

This may allow connectability to the liquid outlet of the centrifugal separator.

Moreover, the tubing arrangement may comprise a first valve for directing the measurement liquid in said single inlet tubing to said first container while preventing transport of the measurement liquid to said second container, and vice versa.

The first valve may thus be a three-way valve. The first valve may in the flow measurement arrangement be arranged upstream of both first and second containers.

Furthermore, the tubing arrangement may comprise a second valve arranged for allowing emptying of said first container of measurement liquid while said second container is being filled with measurement liquid, and a third valve arranged for allowing emptying of said second container of measurement liquid while the first container is being filled with measurement liquid.

The second valve may thus be arranged between the first valve and the first container. The third valve may be arranged between the first valve and the second container. Also the second and third valves may be three-way valves. The second and third valves may be arranged for emptying the containers to tubing arranged downstream of the first and second containers, respectively.

Moreover, the tubing arrangement may comprise a single outlet tubing arranged for transporting the measurement liquid that has been emptied from said first and said second containers out from the flow measurement arrangement.

The single outlet tubing may thus be arranged for transport of all liquid phase that has been emptied from the containers to process equipment downstream.

Furthermore, the tubing arrangement may comprise a fourth valve for allowing measurement liquid emptied form said first and second containers to be transported out from the measurement arrangement via said single outlet tubing.

The fourth valve may thus be arranged downstream of the first and second containers and be connected to the single outlet tubing. The fourth valve may thus be a three-way valve. Measurement liquid that has been emptied from the first container may thus be directed via the second valve to the fourth valve and via the fourth valve to the single outlet tubing. In analogy, measurement liquid that has been emptied from the second container may thus be directed via the third valve to the fourth valve and via the fourth valve to the single outlet tubing.

In embodiments of the first aspect, the separation system further comprises a control unit for controlling the alternately filling the first and second containers with the same type of measurement liquid.

The control unit may thus comprise a processor and communication interface for communicating with the first, second, third and/or fourth valve. The control unit may thus be configured to send operation requests to the first, second, third and/or fourth valve. For this purpose, the control unit may comprise a device having processing capability in the form of processing unit, such as a central processing unit, which is configured to execute computer code instructions which for instance may be stored on a memory. The processing unit may alternatively be in the form of a hardware component.

In embodiments of the first aspect, the first and/or second container is a flexible bag. The first and/or second container may thus be a polymeric bag that is suspended in e.g. a scale.

The first and/or second container may comprise a liquid inlet and a liquid outlet. These may be separate connections, such as separate connections arranged at separate positions on the container. The liquid outlet may be a tubing arranged within the liquid inlet, or vice versa.

However, in embodiments of the first aspect, the liquid inlet is also the liquid outlet of the container. Consequently, the container may be filled and emptied using the same connection for liquid, wherein the connection functions as both the liquid inlet and outlet.

In embodiments of the first aspect, the first and/or second container comprises a liquid inlet for receiving the measurement liquid and a liquid outlet for emptying the liquid phase from the container.

In embodiments of the first aspect, the liquid inlet and/or liquid outlet of the container are arranged in a lower part of the container.

The first and second container may be arranged for being cyclically filled and emptied, and during filling up of the container and when no liquid is leaving the container, the weight increase over time may be evaluated and the liquid flow rate, e.g. the volume flow or the mass flow, may be determined.

In embodiments of the first aspect, the first device for measuring a parameter related to the weight of measurement liquid contained in said first container and/or said second device for measuring a parameter related to the weight of measurement liquid contained in said second container is a scale, such as a suspension scale.

In embodiments of the first aspect, the suspension direction is the vertical direction. Thus, the container may be suspended in the device for measuring a parameter related to the weight of measurement liquid in the vertical direction. The device may thus be a suspension scale, i.e. the container may hang suspended from the scale instead of resting upon it.

The scale may comprise a load cell. Such load cell may thus be a force transducer converting the force such as tension, compression, pressure, or torque into an electrical signal that can be measured. The load cell may thus be a strain gauge load cell. Such load cell may comprise a body that is slightly deformed when applying a load. This, in turn, may causes a change in the electrical resistance of the strain gauge which can be measured as a voltage change that is proportional to the amount of weight applied.

However, the device for measuring a parameter related to the weight of measurement liquid may also be a device for measuring a parameter that is proportional to the weight of the measurement liquid, such as a device for measuring a volume of the measurement liquid in the container.

The mass flow may be calculated by determining a weight increase (Δw) of the container during a time interval (Δt), and then estimate Δw/Δt. The volume flow may be determined from the mass flow using the density of the liquid phase entering the container.

The other parts of the separation system may be as disclosed in WO 2021/191023.

The centrifugal separator may comprise a stationary frame, a rotatable assembly and a drive unit for rotating the rotatable assembly relative the frame around an axis of rotation (X). The centrifugal separator may further comprise a feed inlet for receiving a liquid feed mixture to be separated, at least one liquid outlet for discharge of a separated liquid phase, wherein the rotatable assembly comprises a rotor casing enclosing a separation space in which the separation of said liquid feed mixture takes place during operation, and wherein the separation space is arranged for receiving liquid feed mixture from said feed inlet.

The stationary frame of the centrifugal separator is a non-rotating part, and the rotatable assembly is supported within the frame, e.g. by means of at least one bearing, for example a ball bearing.

The centrifugal separator may further comprise a drive unit arranged for rotating the rotatable assembly and may comprise an electrical motor or be arranged to rotate the rotatable assembly by a suitable transmission, such as a belt or a gear transmission. Thus, the drive unit may be arranged to drive the rotatable assembly directly or indirectly via a transmission.

The rotatable assembly comprises a rotor casing in which the separation takes place. The rotor casing may thus be a centrifuge bowl. The rotor casing encloses a separation space in which the separation of the fluid mixture, such as a cell culture mixture, takes place. The rotor casing may be a solid rotor casing and be free of any further outlets for separated phases. Thus, the solid rotor casing may be solid in that it is free of any peripheral ports for discharging e.g. a sludge phase accumulated at the periphery of the separation space. However, in embodiments, the rotor casing comprises peripheral ports for intermittent or continuous discharge of a separated phase from the periphery of the separation space.

The rotor casing may be arranged for multiple use or be an exchangeable insert arranged for single use.

The feed inlet is for receiving the liquid feed mixture to be separated and for guiding the feed to the separation space.

The separation space may comprise a stack of separation discs arranged centrally around the axis of rotation. The stack may comprise frustoconical separation discs.

The separation discs may thus have a frustoconical shape, which refers to a shape having the shape of a frustum of a cone, which is the shape of a cone with the narrow end, or tip, removed. A frustoconical shape has thus an imaginary apex where the tip or apex of the corresponding conical shape is located. The axis of the frustoconical shape is axially aligned with the axis of rotation of the solid rotor casing. The axis of the frustoconical portion is the direction of the height of the corresponding conical shape or the direction of the axis passing through the apex of the corresponding conical shape.

The separation discs may alternatively be axial discs arranged around the axis of rotation.

The separation discs may e.g. comprise a metal or be of metal material, such as stainless steel. The separation discs may further comprise a plastic material or be of a plastic material.

The centrifugal separator may be arranged to separate the liquid feed mixture into at least one liquid phase, such as into at least a first and second liquid phase. Separated liquid phases may be discharged via first and second liquid outlets. The first liquid outlet, also denoted liquid light outlet, is for discharging a separated liquid phase of a lower density, whereas the second liquid outlet, also called the liquid heavy outlet, is for separating a phase of a higher density than the liquid phase that is discharged via the first liquid outlet.

The flow measurement arrangement may be arranged either downstream of the first liquid outlet and/or downstream of the second liquid outlet. In embodiments, there is a flow measurement arrangement arranged downstream of both liquid outlets.

The first and second containers may be arranged for being filled up and emptied, e.g. in a cyclic manner. Thus, in embodiments of the first aspect, the first and/or second container is not a storage container for long term storage of any separated liquid phase.

Consequently, in embodiments of the first aspect, the separation system comprises a tank for receiving liquid phase being emptied from the flow measurement arrangement.

The tank may be arranged for long term storage of a separated liquid phase. The tank may thus have a volume that is larger than the volume of the first and containers. The tank may have a volume that is at least five, such as at least ten, such as at least 25 times the volume of the first and second container. The tank may e.g. be of stainless steel.

In embodiments, the container is arranged for holding a volume of at least 100 ml, such as at least 500 ml. Moreover, the container may have a maximum volume of less than 5000 ml, such as less than 2500 ml, such as less than 1500 ml, such as 1000 ml or less.

In embodiments of the first aspect of the invention, the separation system further comprises a control unit configured for determining the weight increase of the first and second containers as a function of time. Such control unit may be the same as the control unit used for controlling the alternately filling the first and second containers with the same type of measurement liquid.

The control unit may further be configured to determine or calculate the flow of the liquid phase being discharged to the container based on the measured weight increase as a function of time.

The control unit may comprise computer program products configured for determining the weight increase as a function of time. The control unit may thus comprise a processor and communication interface for communicating with the scale.

For this purpose, the control unit may comprise a device having processing capability in the form of processing unit, such as a central processing unit, which is configured to execute computer code instructions which for instance may be stored on a memory. The processing unit may alternatively be in the form of a hardware component.

As an example, the control unit may further be configured for determining a flow rate of measurement liquid based on the measured weight increase of the first and second container as a function of time. The flow rate may be a mass flow or a volume flow.

Thus, the weight increase of the container may be measured when there is no emptying of the container, i.e. when there is just a fill-up of the container.

The use of the flow measurement arrangement for measuring a parameter related to the weight of measurement liquid allows for omitting the use of further flow sensors since the liquid flow may be determined from the measured weight increase. Consequently, in embodiments of the first aspect, the separation system may be free of any flow sensor arranged downstream of a liquid outlet at which, or downstream which, flow measurement arrangement is arranged. That is, the centrifugal separator may be free of any additional flow sensor other than the flow measurement arrangement arranged downstream of the relevant liquid outlet or outlets.

As a second aspect of the invention, there is provided a method for measuring the flow rate of a measurement liquid in a separation system comprising a centrifugal separator, said measurement liquid being selected from a liquid feed mixture and a separated liquid phase, said method comprising the steps of
a) filling a first container with said measurement liquid;
b) measuring how a parameter related to the weight of the measurement liquid in said first container changes over time during step a);
c) filling a second container with the same type of measurement liquid as in step a);
d) measuring how a parameter related to the weight of the measurement liquid in said second container changes over time during step c); and
e) determining said flow rate of a measurement liquid based on the measurements of step b) and/or step c).

This aspect may generally present the same or corresponding advantages as the former aspect. Effects and features of this second aspect are largely analogous to those described above in connection with the first aspect. Embodiments mentioned in relation to the first aspect are largely compatible with the second aspect.

Step a) of filling the first container may also comprise stopping any outflow of measurement liquid from the first container. In analogy, step c) of filling the second container may comprise stopping any outflow of measurement liquid from the second container.

The parameter of steps b) and/or d) may be the weight. The weight may be measured using a scale, such as a suspension scale. The mass flow may be calculated by determining a weight increase (Aw) of a container during a time interval (At), and then estimate Aw/At. The volume flow may be determined from the mass flow using the density of the liquid phase entering the container.

In embodiments of the second aspect, step c) is performed while emptying said first container of said measurement liquid.

Thus, in embodiments of the second aspect, the parameter related to the weight of the measurement liquid is the weight of the measurement liquid measured by a scale.

Step e) of determining flow rate may be performed at discrete time points, such as once each second. Step e) may be performed simultaneously as steps b) and/or d) are performed.

In embodiments of the second aspect, the method further comprises the step of
f) refilling said first container with said measurement liquid while emptying said second container of said measurement liquid.

Steps a) and f) may be part of a first filling cycle and thus a first measurement cycle.

Step c) may thus be part of a second filling cycle and thus a second measurement cycle.

In an embodiment, the first measurement cycle comprises step f) and the second measurement cycle comprises step (c).

In embodiments of the second aspect, the method comprises repeating the first measurement cycle after the second measurement cycle and repeating the second measurement cycle after the first measurement cycle. Thus, the method my comprise performing the first measurement cycle, thereafter performing the second measurement cycle, thereafter performing the first measurement cycle, and so on.

In embodiments of the second aspect, the separation system is a separation system according to any embodiment described in relation to the first aspect above.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 is a schematic view of a separation system of the present disclosure in which flow measurement arrangement is arranged downstream the first liquid outlet.

FIG. 2 is a schematic view of the separation system of FIG. 1 further comprising a control unit.

FIG. 3 is a schematic view of a separation system of the present disclosure in which a flow measurement arrangement is arranged downstream the second liquid outlet.

FIG. 4 is a schematic illustration of a separation system for separating a cell culture mixture.

FIG. 5 is a schematic illustration of a flow measurement arrangement according to an embodiment of the present disclosure that may be used in the separation system.

FIG. 6 illustrates a first measurement cycle of the flow measurement arrangement.

FIG. 7 illustrates a second measurement cycle of the flow measurement arrangement.

FIG. 8 schematically shows different steps of a method of the present disclosure.

### DETAILED DESCRIPTION

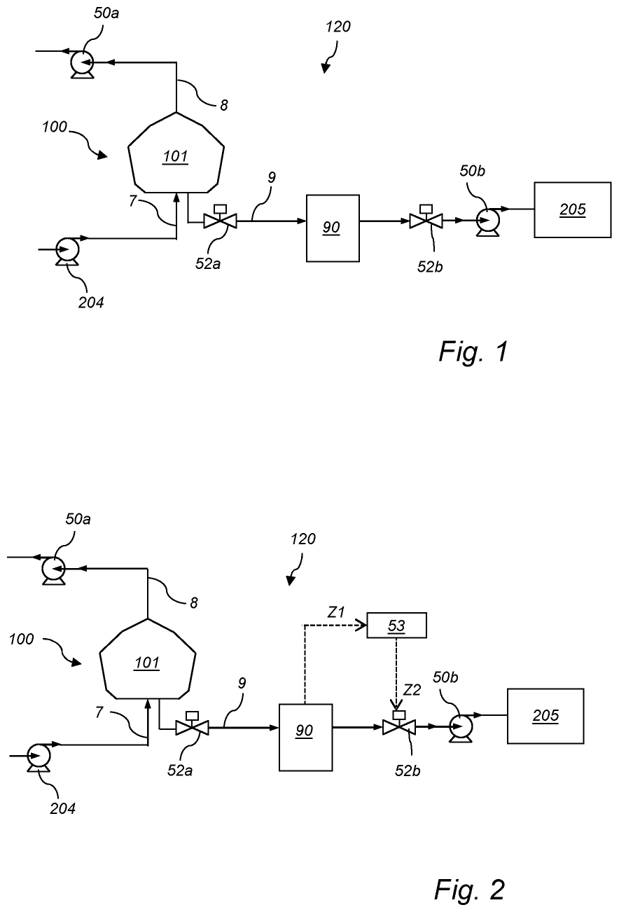

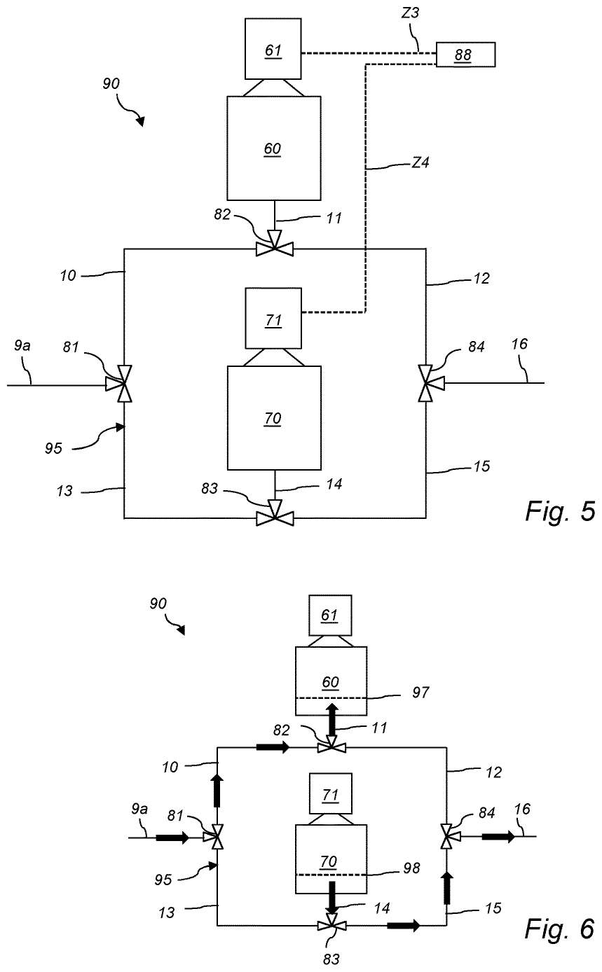

FIGS. 1-4 generally describes the separation system as a whole, whereas FIGS. 5-7 show details of the flow measurement arrangement. In FIGS. 1-4, the flow measurement arrangement 90 is arranged downstream one the liquid outlets of the centrifugal separator, i.e. the measurement liquid is a separated liquid phase. However, the flow measurement arrangement might as well be arranged upstream of the inlet of the centrifugal separator, i.e. such that the measurement liquid is the liquid feed mixture.

FIG. 1 schematically shows a separation system 120 according to embodiments of the present disclosure. For clarity reasons, only the outside of a rotatable assembly 101 of the centrifugal separator 100 is shown.

As discussed above, the centrifugal separator may be as disclosed in WO 2021/191023. Thus, the centrifugal separator may have a rotatable assembly that is arranged for multiple use, such as a traditional stainless steel centrifuge bowl, or a rotatable assembly that is arranged for single use, such as a replaceable insert as known from e.g. WO 2020/120357.

In the centrifugal separator 100 of FIG. 1, liquid feed mixture to be separated is supplied to the rotatable assembly 101 via stationary inlet pipe 7 by means of a feed pump 204. In this example, the liquid feed mixture is separated into a liquid light phase and a liquid heavy phase.

After separation within a separation space of the rotatable assembly, separated liquid light phase is discharged through a first liquid outlet to a first stationary outlet pipe 9, whereas separated heavy phase is discharged via a second liquid outlet to a second stationary outlet pipe 8.

The first 9 and second 8 stationary outlet pipes may be flexible tubing.

Downstream of the second liquid outlet, there is a peristaltic pump 50a arranged for facilitating discharge of the second liquid phase. The peristaltic pump 50a also functions as a regulating valve and may thus be used for regulating the flow, or shutting off the flow, of separated heavy phase being discharged in stationary pipe 8.

Downstream of the first liquid outlet, there is a regulating valve 52a for regulating the discharge of separated liquid light phase in stationary outlet pipe 9. Downstream of this regulating valve, there is a flow measurement arrangement 90 arranged for receiving the discharged liquid light phase and for measuring the flow rate of the discharge liquid phase. The flow measurement arrangement 90 is described in further detail in relation to FIGS. 5-8 below.

As also illustrated in FIG. 1, liquid light phase that has been emptied from the flow measurement arrangement 90 is collected in a tank 205. This tank 205 has a larger volume than the containers of the flow measurement arrangement 90. The tank 205 may be used for intermediate storage, or long-term storage, before further processing of the discharged liquid light phase. The tank 205 may have a volume that is at least five times, such as at least ten times, larger than the volume of the containers of the flow measurement arrangement 90.

FIG. 2 illustrates an embodiment of a separation system 120. The system 120 has a similar set up as the separation system 120 illustrated in FIG. 1, with the addition of the flow measurement arrangement 90 having a control unit 53 configured for determining the flow rate based on the input from the weighing of the containers 60, 70 of the flow measurement arrangement 90. Thus, the control unit 53 is configured for receiving measurement data of the weight of the container 60, e.g. continuously or at discrete points in time. This is illustrated by arrow “Z1” in FIG. 2. Moreover, the control unit 53 is further configured for determining the flow of discharged separated liquid phase based on the measured weight increase of the containers 60, 70 as a function of time. The control unit 53 is in this embodiment also connected to the shutoff valve 52b, as illustrated by arrow “Z2”. The control unit 53 comprises a communication interface, such as a transmitter/receiver, via which it may receive weight data from the scales 61, 71 of the flow measurement arrangement 90. The control unit 53 is thus configured for receiving information of the weight as a function of time of the containers 60, 70 of the flow measurement arrangement 90.

The control unit 53 may further be configured to determine the flow rate of liquid light phase being discharged using the measured weight of the containers 60 ,70 as a function of time. For this purpose, the control unit 53 may comprise a device having processing capability in the form of processing unit, such as a central processing unit, which is configured to execute computer code instructions which for instance may be stored on a memory. The processing unit may alternatively be in the form of a hardware component, such as an application specific integrated circuit, a field-programmable gate array or the like.

The control unit 53 is in this example also configured for regulating the liquid flow through the shutoff valve 52b. For this purpose, the processing unit of the control unit 53 may further comprise computer code instructions for sending operational requests to the shutoff valve 52b.

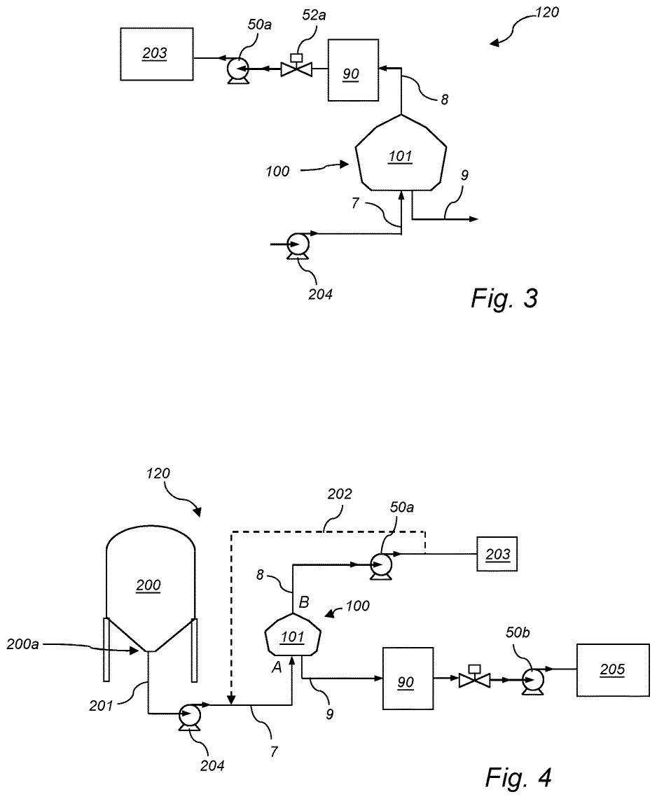

It is to be understood that a flow measurement arrangement 90 for measuring the weight of measurement liquid may be arranged downstream of the second liquid outlet as well and may thus be used for measuring the flow rate of the discharged liquid heavy phase. This is illustrated in FIG. 3. Thus, the separation system 120 may comprise a flow measurement arrangement 90 for measuring the weight of measurement liquid downstream either one of the liquid outlets or downstream both of the liquid outlets.

FIG. 4 is a schematic illustration of a separation system 120 for separating a cell culture mixture. The system 120 comprises a fermenter tank 200 configured for comprising a cell culture mixture. The fermenter tank 200 has an axially upper portion and an axially lower portion 200a. Fermentation in the fermentation tank 200 may for example be for expression of an extracellular biomolecule, such as an antibody, from a mammalian cell culture mixture. After fermentation, the cell culture mixture is separated in a centrifugal separator 100. As seen in FIG. 4, the bottom of the fermenter tank 200 is connected via a connection 201 to the bottom of the separator 100 to the inlet conduit 7 of the separator. However, cell culture mixture could also be supplied from the top of the centrifugal separator 100.

The connection 201 may be a direct connection or a connection via any other processing equipment, such as a tank. Thus, the connection 201 allows for supply of the cell culture mixture from the axially lower portion 200a of the fermenter tank 200 to the inlet of the centrifugal separator 100, as indicated by arrow “A”. There is a feed pump 204 arranged for pumping the feed, i.e. the cell culture mixture from fermentation tank 200, to the inlet of the separator 100.

After separation, the separated cell phase of higher density is discharged via the second liquid outlet at the top of the separator to stationary outlet conduit 8, whereas the separated liquid light phase of lower density, comprising the expressed biomolecule, is discharged via the liquid light phase outlet at the bottom of the separator 100 to stationary outlet conduit 9.

The flow rate of the separated liquid light phase discharged via stationary outlet conduit 9 is determined by flow measurement arrangement 90, described further below.

The positive displacement pumps 50a, 50b may provide suction forces to the measurement liquids thus allowing for a lower feed pressure to be used with feed pump 204, which thus facilitates a gentler treatment of the cells in the separator 100. As an alternative, the feed pump 204 may be completely omitted, and the cells may be drawn to the separator 100 solely by the use of the suction force generated by the positive displacement pumps 50a, 50b.

The separated cell phase may be discharged to a tank 203 for re-use in a subsequent fermentation process, e.g. in the fermenter tank 200. The separated cell phase may further be recirculated to the feed inlet of the separator 100, as indicated by connection 202. The separated liquid light phase may be discharged via outlet conduit 9 to further tank 205 or other process equipment for subsequent purification of the expressed biomolecule.

FIG. 4 shows a more detailed view of an embodiment of a flow measurement arrangement 90 that may be arranged downstream or upstream of a centrifugal separator 100 and arranged for receiving measurement liquid, such as liquid feed mixture or a discharged liquid phase.

The flow measurement arrangement 90 comprises a first container 60 for holding measurement liquid, which is suspended in a first suspension scale 61 for measuring the weight of measurement liquid contained in the first container 60.

Further, the low measurement arrangement 90 comprises a second container 70 for holding measurement liquid, which is suspended in second suspension scale 71 for measuring the weight of measurement liquid contained in the second container 60.

The first 60 and second 70 containers are arranged in parallel connections, so that three-way valve 81 may be used to determine to which container measurement liquid is to be guided.

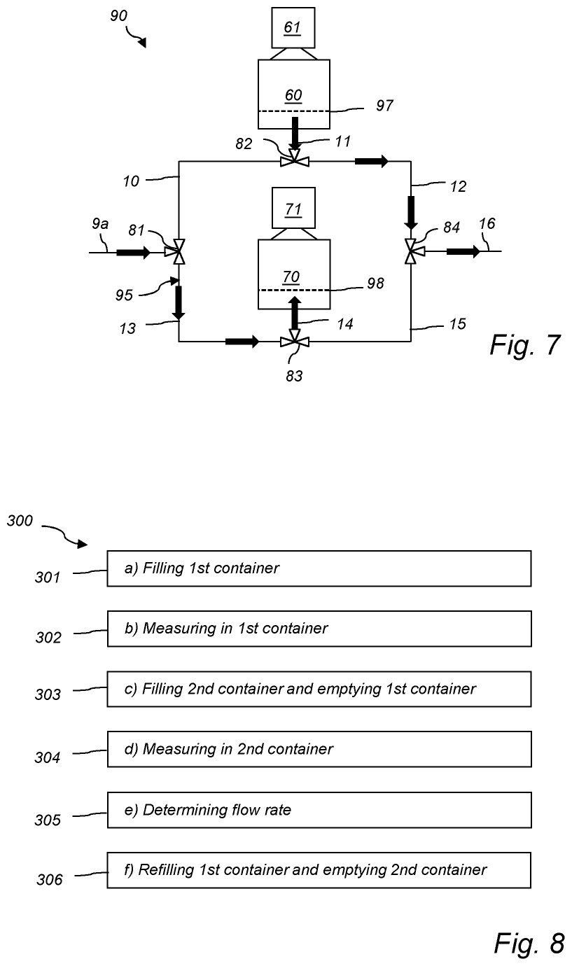

Further, the flow measurement arrangement 90 is arranged to allow emptying of the first container 60 of measurement liquid while the second container 7 is being filled with measurement liquid and vice versa. This is facilitated by the tubing arrangement 95 and by changing valves 82, 83 and 84 as discussed in relation to FIGS. 6 and 7 below. In this way, the flow measurement arrangement 90 allows for alternately filling the first 60 and second 70 containers with the same type of measurement liquid so that measurement of the discharged flow may be performed with no or little interruption.

The first 60 and second 70 containers are flexible bags each having a container inlet for receiving the discharged separated liquid light phase and a container outlet for emptying the liquid phase from the container. In this embodiment, the inlet and outlet is the same tubing, i.e. tubing 11 for the first container 60 and tubing 14 for the second container 70. Thus, filling and emptying of a container is performed via the same tubing.

The first 60 and second 70 containers are both flexible bags that each are suspended in a scale. Thus, suspension scale 61 is configured for measuring the weight of the container 60, whereas suspension scale 71 is configured for measuring the weight of the container 70.

The measured weight of separated liquid light phase in a container is thus a measure of the amount of liquid light phase being discharged, and such measurements of the weight of the scale may be used for calculating the discharged flow rate of the separated liquid light phase.

Control unit 88 may also be a part of the flow measurement arrangement 90. This unit receives weight values from the first suspension scale 61, as indicated by arrow “Z3”, and weight values from the second suspension scale 71, as indicated by arrow “Z4”, and from this calculates the flow rate, e.g. by measuring the mass flow determining a weight increase as a function of time. The flow rate may be determined at discrete time points, such as once every second. The control unit 88 may be the same control unit 53 used in the system 120 for e.g. control of other regulation valves.

Tubing arrangement 95 is used for transporting measurement liquid to and from the first container 6 and to and from the second container 70. The tubing arrangement 95 comprises a single inlet tubing 9a for receiving the measurement liquid that is to be filled in the containers 60 and 70, and a first valve 81 for directing the received measurement liquid into the first container 60 in tubing 10 while preventing transport of the measurement liquid to the second container 70 in tubing 13 and vice versa.

Moreover, the tubing arrangement 95 comprises second valve 82 arranged on the tubing between the first valve 81 and the first container 60. This three-way valve 82 may be used for emptying of the first container 60 into downstream tubing 12 of measurement liquid while the second container 70 is being filled with measurement liquid.

In analogy, the tubing arrangement 95 comprises third valve 83 arranged on the tubing between the first valve 81 and the second container 70. This three-way valve 83 may be used for emptying of the second container 70 into downstream tubing 15 of measurement liquid while the first container 60 is being filled with measurement liquid.

Further, the tubing arrangement 95 comprises a single outlet tubing 16 downstream of tubing 12, which is downstream the first container 60, tubing 15, which is downstream of the second container 70, and a fourth valve 84 for allowing measurement liquid emptied form the first 60 and second 70 containers to be transported out from the measurement arrangement 90 via the single outlet tubing 16. Liquid leaving the flow measurement arrangement 90 via the single outlet tubing 16 may be transported to a pipe or tubing that is in fluid contact with a tank, such as tank 205 shown in FIG. 2.

FIGS. 6 and 7 illustrate the two filling and measurement cycles. The path of the liquid is illustrated by bold arrows in FIGS. 6 and 7.

In FIG. 6—which illustrates a first measurement cycle—the incoming measurement liquid in the single inlet tube 9a is directed to the first container 60 using the first valve 81 and the second valve 82. Thus, the liquid level 97 of the first container 60 rises, and the increased weight of the first container 60 is measured by scale 61 so that the flow rate of the measurement liquid may be determined. At the same time, any liquid in the second container 70 is emptied from the second container 70 to the single outlet tube 16 using the third valve 83 and the fourth valve 84. Thus, liquid level 98 of the second container decreases. The path of the liquid is illustrated by bold arrows in FIG. 6.

In FIG. 7—which illustrates a second measurement cycle—the incoming measurement liquid in the single inlet tube 9a is directed to the second container 70 using the first valve 81 and the third valve 83. Thus, the liquid level 98 of the second container 70 rises, and the increased weight of the second container 70 is measured by scale 71 so that the flow rate of the measurement liquid may be determined. At the same time, any liquid in the first container 60 is emptied from the first container 60 to the single outlet tube 16 using the second valve 82 and the fourth valve 84. Thus, liquid level 97 of the first container 60 decreases.

With the first and second measurement cycles, there may be a more or less continuous determination of the flow rate of a measurement liquid from a centrifugal separator.

FIG. 8 illustrates the steps of the method 300 used for measuring the flow rate of a measurement liquid in a separation system comprising a centrifugal separator. The separation system may be a separation system as discussed herein above. The method 300 comprises the steps of
a) filling 301 a first container 60 with said measurement liquid;
b) measuring 302 how a parameter related to the weight of the measurement liquid in said first container 6 changes over time during step a);
c) filling 303 a second d container 70 with said measurement liquid. This step may be performed while emptying said first container 60 of said measurement liquid;
d) measuring 304 how a parameter related to the weight of the measurement liquid in said second container 70 changes over time during step c); and
e) determining 305 said flow rate of a measurement liquid based on the measurements of step b) and/or step c).

In this example, the method 300 further comprises the step of
f) refilling 306 the first container 60 with said measurement liquid while emptying said second container 70 of said measurement liquid.

As discussed herein above, the parameter related to the weight of the measurement liquid may be the weight of the measurement liquid measured by a scale.

In the above, the inventive concept has mainly been described with reference to a limited number of examples. However, as is readily appreciated by a person skilled in the art, other examples than the ones disclosed above are equally possible within the scope of the inventive concept, as defined by the appended claims.

1. A separation system comprising:
a centrifugal separator for separating a liquid feed mixture, wherein the centrifugal separator is arranged for separating the liquid feed mixture into at least one separated liquid phase and discharging said at least one separated liquid phase; and
a flow measurement arrangement arranged for receiving a measurement liquid selected from the liquid feed mixture and the at least one separated liquid phase, wherein the flow measurement arrangement comprises:
a first container for holding measurement liquid;
a first device for measuring a parameter related to a weight of measurement liquid contained in said first container;
a second container for holding measurement liquid; and
a second device for measuring a parameter related to a weight of measurement liquid contained in said second container,
wherein the flow measurement arrangement is further arranged to allow emptying said first container of measurement liquid while a further container of the flow measurement arrangement is being filled with the same type of measurement liquid and vice versa, thereby allowing alternately filling the first container and the further container of the flow measurement arrangement with the same type of measurement liquid.

2. The separation system according to claim 1, wherein the further container of the flow measurement arrangement is the second container.

3. The separation system according to claim 2, wherein the flow measurement arrangement comprises a tubing arrangement for transporting measurement liquid to and from the first container and to and from the second container.

4. The separation system according to claim 3, wherein said tubing arrangement comprises a single inlet tubing for receiving the measurement liquid that is to be filled in said first and said second containers.

5. The separation system according to claim 4, wherein the tubing arrangement comprises a first valve for directing the measurement liquid in said single inlet tubing to said first container while preventing transport of the measurement liquid to said second container, and vice versa.

6. The separation system according to claim 5, wherein the tubing arrangement comprises a second valve arranged for allowing emptying of said first container of measurement liquid while said second container is being filled with measurement liquid, and a third valve arranged for allowing emptying of said second container of measurement liquid while the first container is being filled with measurement liquid.

7. The separation system according to claim 3, wherein said tubing arrangement comprises a single outlet tubing arranged for transporting the measurement liquid that has been emptied from said first and said second containers out from the flow measurement arrangement.

8. The separation system according to claim 7, wherein said tubing arrangement comprises a fourth valve for allowing measurement liquid emptied from said first and second containers to be transported out from the measurement arrangement via said single outlet tubing.

9. The separation system according to claim 1, further comprising a control unit for controlling the alternately filling the first and further containers with the same type of measurement liquid.

10. The separation system according to claim 1, wherein said first container and/or further container is a flexible bag.

11. The separation system according to claim 2, wherein said first device for measuring a parameter related to the weight of measurement liquid contained in said first container and/or said second device for measuring a parameter related to the weight of measurement liquid contained in said second container is a scale.

12. A method for measuring a flow rate of a measurement liquid in a separation system comprising a centrifugal separator, said measurement liquid being selected from a liquid feed mixture to be separated and a separated liquid phase, said method comprising the steps of:
a) filling a first container with said measurement liquid;
b) measuring how a parameter related to a weight of the measurement liquid in said first container changes over time during step a);
c) filling a second container with the same type of measurement liquid as in step a);
d) measuring how a parameter related to a weight of the measurement liquid in said second container changes over time during step c); and
e) determining said flow rate of a measurement liquid based on the measurements of step b) and/or step c).

13. The method according to claim 12, wherein step c) is performed while emptying said first container of said measurement liquid.

14. The method according to claim 13, wherein the method further comprises the step of:
f) refilling said first container with said measurement liquid while emptying said second container of said measurement liquid.

15. A method for measuring a flow rate of a measurement liquid in the separation system according to claim 1, said method comprising the steps of:
a) filling the first container with said measurement liquid;
b) measuring how a parameter related to a weight of the measurement liquid in said first container changes over time during step a);
c) filling a second container with the same type of measurement liquid as in step a);
d) measuring how a parameter related to a weight of the measurement liquid in said second container changes over time during step c); and
e) determining said flow rate of a measurement liquid based on the measurements of step b) and/or step c).

16. The separation system according to claim 4, wherein said tubing arrangement comprises a single outlet tubing arranged for transporting the measurement liquid that has been emptied from said first and said second containers out from the flow measurement arrangement.

17. The separation system according to claim 5, wherein said tubing arrangement comprises a single outlet tubing arranged for transporting the measurement liquid that has been emptied from said first and said second containers out from the flow measurement arrangement.

18. The separation system according to claim 6, wherein said tubing arrangement comprises a single outlet tubing arranged for transporting the measurement liquid that has been emptied from said first and said second containers out from the flow measurement arrangement.

19. The separation system according to claim 2, further comprising a control unit for controlling the alternately filling the first and second containers with the same type of measurement liquid.

20. The separation system according to claim 3, further comprising a control unit for controlling the alternately filling the first and second containers with the same type of measurement liquid.
